(19) United States
(12) Patent Application Publication
(10) Pub. No.: US 2007/0230586 A1
(43) Pub. Date: Oct. 4, 2007

(54) Encoding, decoding and transcoding of audio/video signals using combined parallel and serial processing techniques

(75) Inventors: Sudy Shen, Richmond Hill (CA); Christian Saceanu, (US); David Ewing, Whitby (CA)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Masstech Group Inc., Richmond Hill (CA)

(21) Appl. No.: 11/732,028

(22) Filed: Apr. 2, 2007

Related U.S. Application Data
(60) Provisional application No. 60/787,854, filed on Mar. 31, 2006.

(51) Int. Cl. H04N 7/12

(52) U.S. Cl. 375/240.26

(57) ABSTRACT

An efficient system and process is utilized to achieve encoding, decoding and transcoding of audio/visual signals, as desired within an audio/visual processing system. The system coordinates the operations of several optimum components to achieve the necessary encoding/decoding/transcoding operations. Most significantly, the coordinated use of both a parallel processor and a bitstream processor, along with most effective interface techniques, are utilized to most efficiently carry out processing operations. The bitstream processor generally carries out those operations which include timing and sequence information, while the parallel processor is available to perform processing steps which are most efficiently carried out in parallel. Such processing steps include the actual compression/decompression of video signals. When combined with a system controller to orchestrate operations, along with memory and related interface components, a system and method to efficiently encode, decode or transcode A/V data is achieved.

### CROSS REFERENCE TO RELATED APPLICATIONS

This application claims the benefit of U.S. Provisional Application No. 60/787,854, filed Mar. 31, 2006.

### BACKGROUND OF THE INVENTION

The present invention relates to the management and necessary processing of audio/visual signals. More specifically, the invention is an apparatus and method for increasing the performance of encoding, decoding and transcoding video data streams. The inventive method splits the process of compression and decompression into sequential and parallel processes and employs algorithms and hardware specially developed for each type of process.

Broadcast facilities employ a wide variety of electronic equipment to receive, process and transmit audio-visual content to audiences. One key component in a broadcast content delivery system is a processing system that is capable of receiving and processing audio-visual data (A/V data) so it can ultimately be used for broadcast. A distinguishing characteristic of a A/V processing system, compared with a typical computer system, is the tremendous amount of data that constitutes broadcast quality video. Significant processing is required when analog video is received and converted to a digital form. Similarly, when decoding and transcoding operations are required for digital video signals, significant processing is also necessary. Further, an ongoing need exists for coordinating this large volume of data among various devices within the system in a timely manner, especially during the various steps of encoding, decoding or transcoding operations.

The various processing components typically have different performance and cost characteristics which often determines how they are used within a broadcast content processing system. There are often trade offs in performance for the data processing components usable within the system. Also, trade-offs exist for the types of connections used to interconnect to the components, which control the overall broadcast content management system. For example, certain processors are particularly well suited for sequential processing of data that has timing related information—often referred to as bitstream processors. Similarly, certain operations and certain processors are better suited for parallel processing of data, thus increasing speed and efficiency of the overall system.

Again, systems involving the automated processing and management of audio-visual data are typically very involved and complex. Present day A/V data files often involve large amounts of data and may include many different data formats. These various formats may be appropriate for specific situations such as storage, transmission, editing, etc. However, the overall coordination of A/V data becomes difficult due to the amount of data involved and the aforementioned differences in data format. Specifically, A/V data will typically contain pixel information along with audio, in addition to any timing, syndication, indexing or category information that may be included. Further, the several processing steps typically required for A/V data make its overall coordination more and more difficult. For example, receipt, processing, storage, digitizing, etc. each involve separate operations which must be performed. In an effort to make the overall systems more efficient, it is desirable to process as much information as possible in a consistent digital format. This allows for the efficient processing and storage, and subsequent retrieval, of A/V data. Often, this requires the encoding (digitizing) of analog data to produce information in the necessary format, the decoding of digital data to produce analog video, or the transcoding of digital signals to achieve a desirable format.

As can be appreciated, typical processes involved with A/V data start with the receipt of analog signals representative of the desired display and sound information. This analog data is typically processed and digitized (encoded) so that it can be more easily managed by overall systems controllers. In certain circumstances, a blended format of analog and digital information is provided, which also must be processed and managed by the system.

In addition to the digitizing of A/V data mentioned above, the management of various data types also creates a further challenge. Currently, there are various types of encoded A/V data in use, with each type having advantages of their own. Handling of these various data types requires coordination by an A/V management system. Often, this requires the conversion or transcoding of digitized A/V data so that the desired information exists in the most appropriate format.

In light of the considerations and issues outlined above, it is desirable to create an overall processing system which efficiently receives and appropriately processes A/V data. This system will appropriately encode, decode or transcode A/V data depending on the format received, and the desired output format.

### BRIEF SUMMARY OF THE INVENTION

The present invention addresses the problems outlined above by providing components and methods to efficiently process A/V signal or A/V data. The unique system configuration, utilizing appropriate modules and interface techniques, is set up to efficiently process A/V data and to deal with the unique challenges of this data. More specifically, the system will efficiently decode, encode, or transcode audio-visual information. In order to provide this efficiency, the system of the present invention utilizes parallel processing techniques, along with specific dedicated processing components, to efficiently carry out the necessary tasks. Further, the operations of these processing components are coordinated and managed by a system controller to further enhance efficiencies.

The system of the present invention is generally made up of a system controller, which accommodates communication between itself, a memory, a parallel processor, a bitstream processor, a management processor, and several interface modules. Through these connections, and its internal configuration, the operations of encoding, decoding and transcoding are all efficiently carried out by utilizing the various processing components most advantageously. Generally speaking, the bitstream processor is utilized for those operations requiring sequence or timing information. Similarly, the parallel processor is used for image processing which can be carried out in parallel, thus more efficiently carrying out those operations. To further coordinate these operations, appropriate interface processors and interface coordinators are utilized. Through the configuration and interconnection of these components, efficient video processing is achieved. More specifically, more efficient decoding, encoding and transcoding of video data is carried out.

As suggested above, the efficient encoding of analog video signals received by the processing system is one feature of the present invention. Generally speaking, the analog video signal is received at an analog input device which will digitize the signal and transfer it to the system controller for further handling. The system controller can then perform data remapping operations to optimize further operations by a parallel processor. The parallel processor can then further process the digital A/V data, thus producing a partially encoded A/V data signal. From that point, the partially encoded signal is transferred to the system controller, and on to the bitstream processor. Upon receipt of the partially encoded A/V data, the bitstream processor can then insert appropriate timing information to produce a fully encoded A/V data that can then be stored and/or appropriately utilized by further production systems.

A similar process carried out by the present invention is the decoding of digital video data. As can be anticipated, this process is somewhat similar to the encoding operation outlined above, however carried out in reverse. Most significantly, however, the decoding process efficiently utilizes both a bitstream processor and a parallel processor. More specifically, the digitized A/V data is typically received by an interface module, and then passed via system controller to the bitstream processor. The bitstream processor itself is capable of parsing digital information therefrom to separate timing information and digital video. This parsed information is then passed via system controller on to the parallel processor, which is then capable of decoding the parsed A/V data. Once decoded, the parallel processor is then capable of outputting decoded A/V data to the system controller. Any necessary remapping operations can then be carried out, thus allowing the signal to be transferred from the control processor to the A/V output interface which finally converts the digital A/V signal to an analog video output.

Lastly, the system of the present invention also efficiently carries out transcoding operations, wherein A/V data is received in one format and is efficiently converted to a second format. More specifically, in the transcoding operations of the present invention, digitized A/V data is received at a system input, and is transferred to the bitstream processor, thus producing a parsed A/V data stream. Next, the parallel processor will receive this first parsed A/V data stream, and perform necessary processing to transform it to a second encoded data format. This second set of encoded data is then transferred back to the bitstream processor to perform the final encoding operations in the new format, thus producing a second encoded digital signal. One example of this transcoding operation will receive encoded digital video signal in an MPEG-2, and output an MPEG-4/AVC format.

Generally speaking, using the systems and processes outlined above the system of the present invention achieves the effective encoding/decoding/transcoding of A/V signals as necessary.

### BRIEF DESCRIPTION OF THE DRAWINGS

Further objects and advantages of the present invention will be seen by studying the following detailed description, in conjunction with the drawings in which:

FIG. 1 illustrates a block diagram of the video processing system;

FIG. 2 illustrates schematically the data flow during encoding operations;

FIG. 3 illustrates schematically the decoding process of the present invention;

FIG. 4 illustrates in block format the transcoding operation of the present invention;

FIG. 5 is a block diagram illustrating the main components making up the system controller module;

FIG. 6 is a block diagram illustrating the structure of the present invention's parallel processors;

FIG. 7 is a schematic drawing illustrating the mapping process of the present invention;

FIG. 8 further illustrates remapping operations;

FIG. 9 is a flow chart showing the sequential processes required for decoding;

FIG. 10 is a flow chart illustrating the parallel video decoding operations;

FIG. 11 is a flow chart generally illustrating the parallel process of encoding information;

FIG. 12 is a flow chart illustrating final steps to encode video data.

### DETAILED DESCRIPTION OF THE INVENTION

As generally suggested above, the present invention efficiently and effectively implements encoding, decoding and transcoding operations for an A/V processing system. The advantages of the present invention include the efficient processing operations carried out. As will be further illustrated below, the efficiency of these operations is achieved largely through the coordination of various components which are specifically suited to carry out particular operations. To achieve this coordinated operation, data management, and appropriate communication, must be carried out by a system controller.

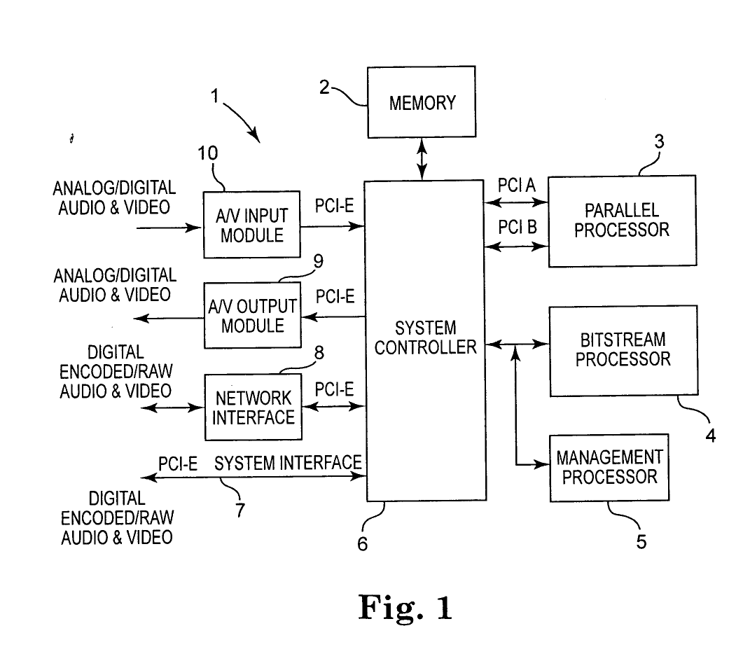

FIG. 1 illustrates the inventive video processing system 1 in a block diagram format, with each block representing a major component of the system. A system controller 6 controls individual data buses used in the system and provides bridging between Peripheral Component Interconnect (PCI) and PCI-Express (PCI-E) buses. System controller 6 also provides overall control and coordination of memory 2, multiple Direct Memory Access (DMA) channels, interrupts and system timing. Connected to System Controller 6 are modules for analog video data input 10 and output 9 and a network interface 8 for the input and output of digital encoded or raw data. Memory module 2, consisting of Random Access Memory (RAM), provides working memory for the DMA channels and also for a bitstream processor 4 and a management processor 5. A system interface 7 provides connectivity for the inventive apparatus to the computer platform on which it resides. Also connected to system controller 6 via dual normal PCI buses is a parallel processor 3, consisting of multiple Single Instruction Multiple Data (SIMD) processors which cooperate to process encoding/decoding/transcoding operations in parallel. Bitstream processor 4 complements parallel processor 3 by handling the aspects of the encode/decode/transcode process that must be handled sequentially including bitstream parsing and generation. In a preferred embodiment bitstream processor 4 is implemented in a Field Programmable Gate Array (FPGA) or similar programmable hardware to enhance operating performance. Management processor 5 manages the peripheral input/output cards, manages and schedules the data flow between bitstream processor 4 and parallel processor 3, loads instruction code into bitstream processor 4 and parallel processor 3, and provides a control point for external (system) applications to access the system's resources via the system interface 7. The above description of the inventive apparatus and method pertains to only the video portion of an audio/video data bitstream; the audio portion of the audio/video data is processed by management processor 5 or by the external system processor (not shown) in a conventional manner.

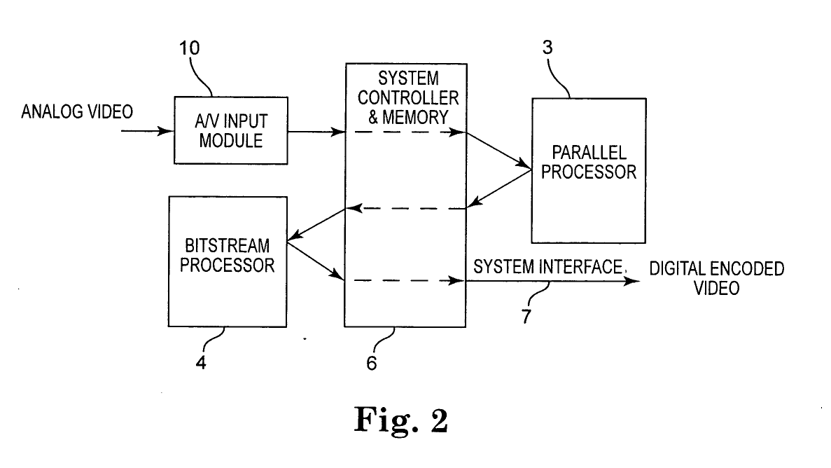

FIG. 2 illustrates schematically the flow of analog video data from A/V input module 10 until it is output as a digitally encoded video signal. Once received at A/V input module 10, the signal is digitized, passed through system controller 6 and passed into RAM (memory module 2) where it is block re-mapped and transferred via a DMA channel to parallel processor 3. At that point, the information is stored in local memory and encoded in parallel. The parallel encoded image is then DMA transferred from parallel processor data memory to RAM in memory module 2. Next, the encoded image is transferred to bitstream processor 4 which completes the data encoding and generates a bitstream of encoded video data. From there the digitally encoded video data stream is sent via DMA to system interface 7.

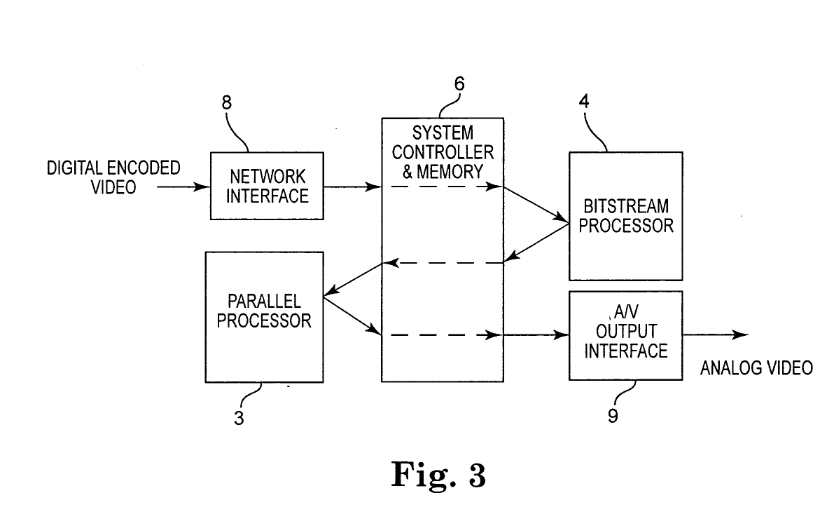

FIG. 3 illustrates schematically the decoding process of the present video processing method and system. Encoded video data flows from a network interface module 8 through system controller 6 and into RAM (memory module 2). From RAM the encoded video stream is parsed by the bitstream processor 4 and the data is partially decoded before a DMA transfer to parallel processor 3 where the decoding is finished. Another DMA transfer moves the data back to RAM where a pixel remap of the data is performed followed by an optional unpacked to packed pixel conversion. Finally, the decoded and remapped data is sent by DMA transfer to A/V Output Interface card 9 where it is converted to analog video.

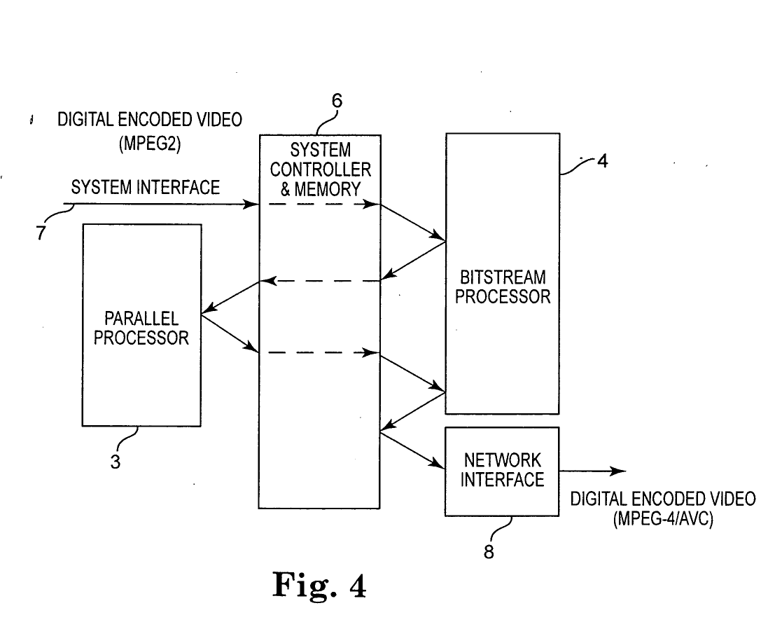

Turning now to FIG. 4, a block diagram illustrates the flow of data through the inventive video processing apparatus in a transcoding operation. Digital video, encoded in a first encoding format (in this example MPEG2) is transferred by system interface 7 to system controller 6 where it is stored in RAM. The encoded data is parsed by bitstream processor 4 and partially decoded before it is sent via DMA to parallel processor 3 where the decoding is completed. After decoding, the data is then encoded using a second encoding format (in this case MPEG4/AVC) in parallel by parallel processor 3 and then transferred via DMA to RAM in system controller 6 and then to bitstream processor 4 where encoding is finalized and a new encoded bitstream is generated. Finally, the newly encoded bitstream is sent via network interface 8 to external applications.

As illustrated in FIGS. 2-4 above, the system 1 makes efficient use of resources by coordinating the operation of bitstream processor 4 and parallel processor 3. Generally speaking, bitstream processor 4 is utilized to perform operations requiring some type of sequencing. Similarly, parallel processor 3 is used to perform encoding and decoding operations, which are efficiently carried out in parallel. System controller 6 makes efficient use of these resources by appropriately managing the transfer of data.

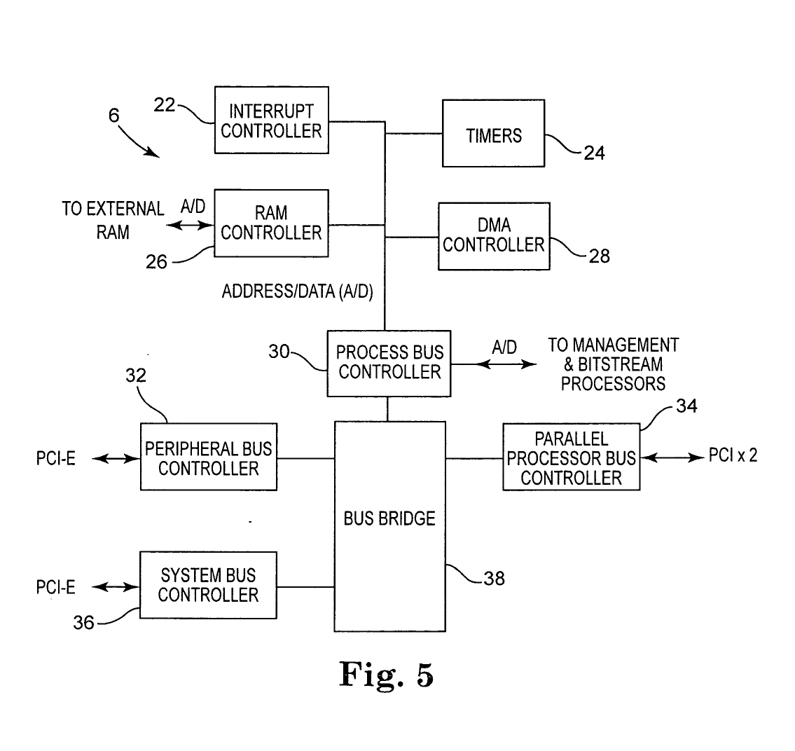

FIG. 5 is a block diagram showing the main components of the system controller module 6. A process bus controller 30 controls the flow of data to and from management processor 5 and bitstream processor 4. Connected to process bus controller 30 is a bus bridge 38 which facilitates the transfer of data to and from parallel processor 3 via 2 PCI buses through parallel processor bus controller 34. Also connected to bus bridge 38 are two PCI-E bus controllers—a main system bus controller 36 and a peripheral components bus controller 32, configured to communicate with A/V input module 10, A/V output module 9 and network interface 8. In addition to being connected with management processor 5, bitstream processor 4 and bus bridge 38, process bus controller 30 is connected with other components which facilitate the flow of data through the system including a RAM controller 26, a DMA controller 28, an interrupt controller 22 and a timing module 24. In a preferred embodiment, system controller 6 and its component modules are readily available off-the-shelf computer components.

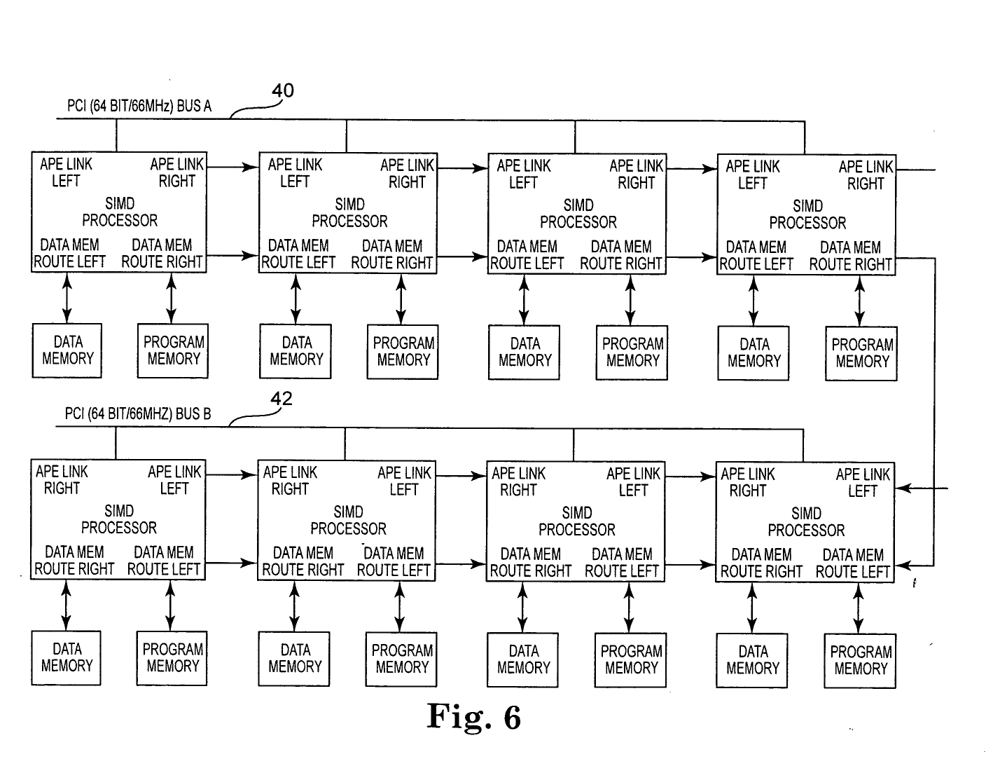

FIG. 6 is a block diagram illustrating the structure of the parallel processor 3. Two separate PCI 64 bit buses 40 and 42 are each connected with 4 SIMD processors 44, for a total of eight SIMD processors. Each SIMD processor has a local program memory store 48 and a local data memory store 46. In a preferred embodiment, each SIMD processor contains an array of 4096 Associative Processing Elements (APE). Each APE within each SIMD processor consists of a 2 bit Arithematic Logic Unit (ALU) and 192 bits of associatively accessible memory. Each ALU can process an operation on one pixel enabling the array to operate on 4096 pixels in parallel. For decode and transcode operations, the system loads a slice of a picture into each data memory 46 so that each SIMD processor works on different sections of the picture in parallel. The SIMD processors have left and right data memory routing allowing cooperation between processors if needed for processing across slice boundaries. This is important for encoding operations since processing can be distributed across multiple SIMD processors to facilitate the generation of motion vector data. In addition to data memory access left and right, there is also an APE array access left and right which allows large block operations which may not fit within one SIMD processor to be carried out effectively using cross SIMD processor communication. An example of a suitable SIMD processor for use in the invention is a Linedancer processor manufactured and distributed by Aspex Semiconductor.

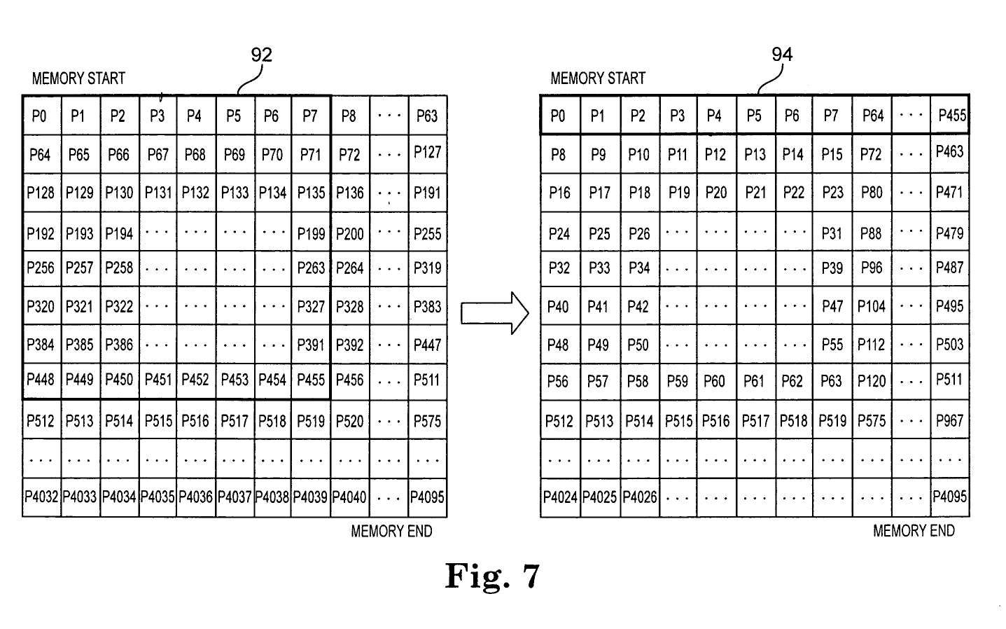

Encoding or compressing video data typically involves organizing image data into blocks of pixels which can reveal image data redundancies within a video frame and between sequential frames. FIG. 7 is a schematic showing the memory remapping required to move from pixel to block oriented memory for use in the parallel processor 3. The operation of remapping the video data to a block orientation prior to parallel processing is desirable because it increases the system's efficiency in loading and processing the data. A hypothetical 64×64 pixel image is illustrated in FIG. 7 having 8×8 pixel blocks. Pixel block 92 is indicated by the dark boundary and its constituent pixels are arranged as they would appear on a raster scanned device such as a monitor or projector. In the second diagram, the pixels have been re-mapped resulting in pixel block 92 being transformed to pixel block 94 which contains the same pixels as block 92 but is transformed from an 8×8 array to a 1×64 array. This new orientation allows whole blocks to be loaded/unloaded into SIMD processors without the need for special memory access routines which would hamper the parallel processor performance.

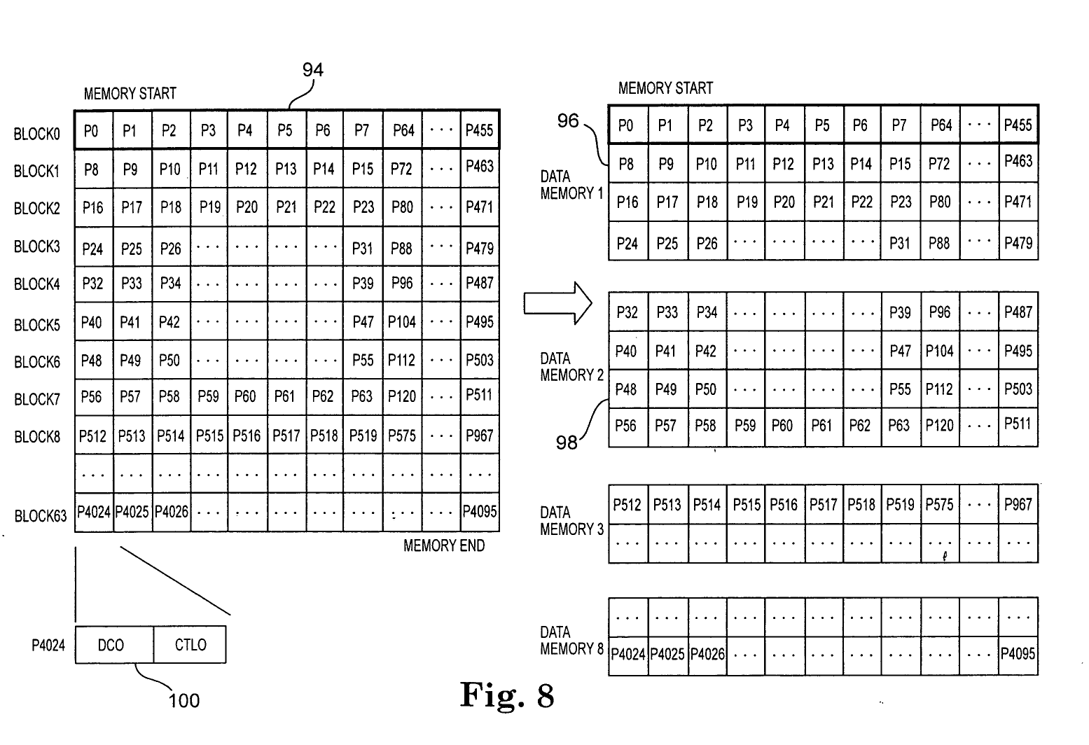

FIG. 8 illustrates a pixel data structure which is advantageous when using parallel processing to encode/decode/transcode video data. An illustrative pixel 100 is shown as containing two words, a video data word 102 which contains data describing the picture content of the pixel (luminance and chrominance values) and a control word 104 which is necessary to allow control information to be loaded into the SIMD processor's APE at the same time as the data. Control word 104 holds the block address within the picture and flags which define various control fields required for compression/decompression. The motion vector data recovered from bitstream decoding is transferred in the same fashion. Similarly for encoding, the motion vector data as derived from the parallel motion estimation routines is loaded into this data structure for use later by the bitstream generator. The second diagram in FIG. 8 shows the arrangement of data blocks into image slices which are sent to the data memory stores of SIMD processors. Data slices 96 and 98 are each comprised of 4 data blocks of 64 pixels each for a total of 256 pixels per slice. In a more realistic example the amount of pixels in a data slice would be at least an order of magnitude greater.

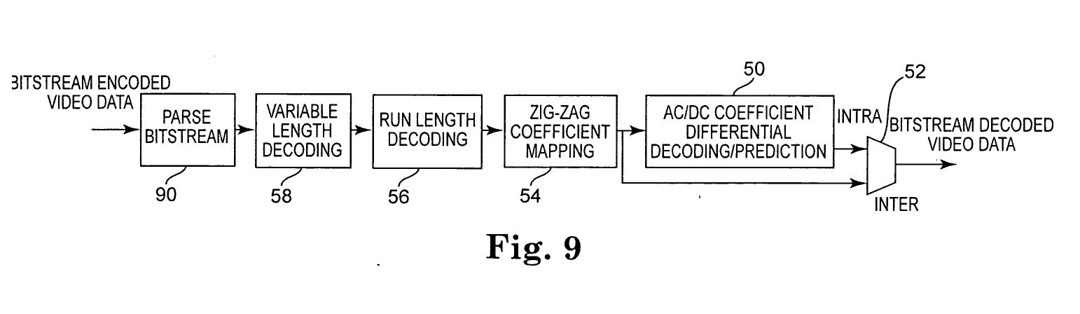

FIG. 9 is a flowchart showing the sequential processes required for decoding encoded video data prior to sending the data to parallel processor 3. A bitstream of encoded video data passes sequentially through a parsing module 90, a variable length decoding module 58, a run length decoding module 56 and a zigzag coefficient mapping module 54. If the data is an intra (I frame—using data within the frame only) encoded frame it is sent to an AC/DC coefficient differential decoding/prediction module 50 and then on to gate 52. If the data is an inter-(B or P frame) encoded frame it is sent directly to gate 52. Both types of frames are then sent as a bitstream to system controller 6 and then on to parallel processor 3 for further decoding. Further detail regarding bitstream processor 4, and the serial processing steps carried out by that component can be found in applicant's co-pending application entitled “Serial Processing of Video Signals Using Programmable Hardware Device”, U.S. application Ser. No. ______, filed concurrently with the present application and incorporated herein by reference.

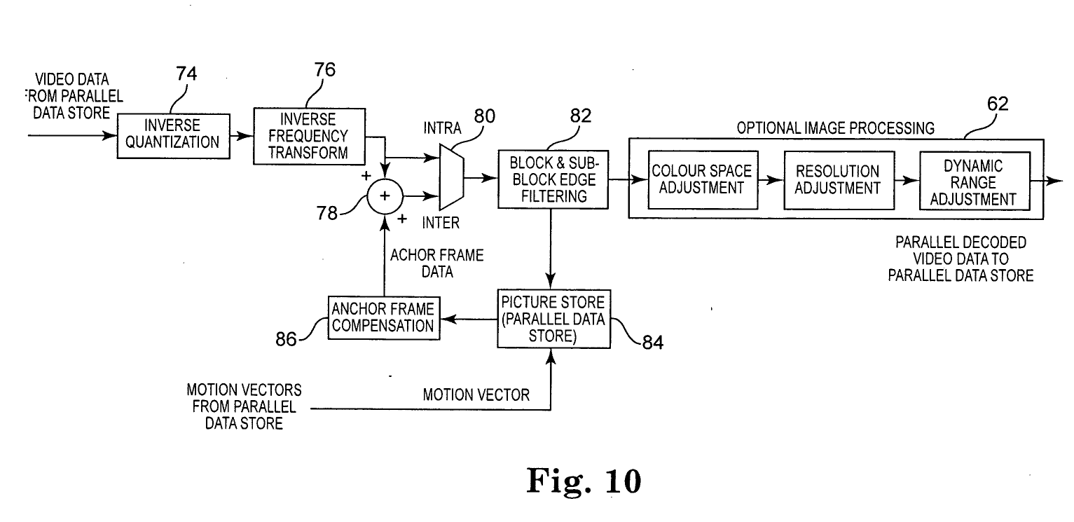

FIG. 10 is a flowchart illustration of the parallel portions of a video decode operation. Partially decoded video data from a parallel data store is processed by an inverse quantization module 74 and then by an inverse frequency transform module 76 before reaching gate 80. If the current frame is an intra encoded frame (I frame) it is sent to an edge filtering module 82 and then to picture store 84 where it is used with motion vector data stored in the parallel data store to provide motion vector error data. An anchor frame compensation module 86 compensates for scaling differences between anchor frame data and current frame data and provides corrected anchor frame data which is summed with previous anchor frame data at summator 78 to create the recovered frame data needed to decode subsequent inter-coded (B and P) frames. After decoding the frame, data is sent to an optional image processing module 62 for color space, resolution, and/or dynamic range adjustment if necessary and then on to a parallel data store.

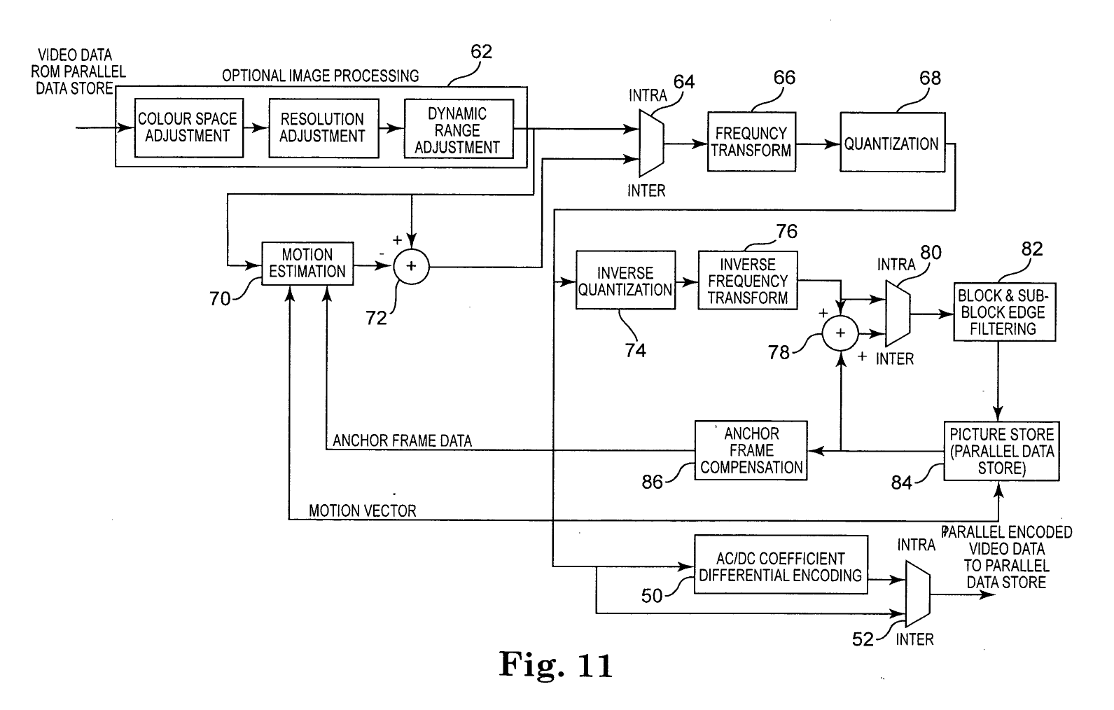

FIG. 11 is a generalized flowchart of the parallel portions of an encode operation. Video data from a parallel data store is sent to an optional image processing module 62 for color, resolution and or dynamic range adjustments, if necessary. From there the data is sent to gate 64 and on to a frequency transform module 66, and a quantization module 68. The resulting transformed and quantized data may be used to generate motion estimates for predicting inter-frame data. First the quantized data is decoded to get anchor frame data which is fed back to motion estimation module 70 along with motion vector data and inter-frame data. Then the resulting motion data is subtracted at summator 72 from inter-frame data to generate an estimate of motion error for the resulting motion vector. The motion vector and motion error data is then incorporated into the data stream and is used in subsequent decoding to recreate the inter frame images. The anchor frame data is generated using the same modules used for decoding mention above including: inverse quantization module 74; inverse frequency transform module 76; summator 78; gate 80; edge filtering module 82; picture store 84 and anchor frame compensation module 86. Intra frame parallel encoded video data is sent to an AC/DC coefficient differential encoding module 50 and then to gate 52. After encoding both intra and inter data is sent to a parallel data store.

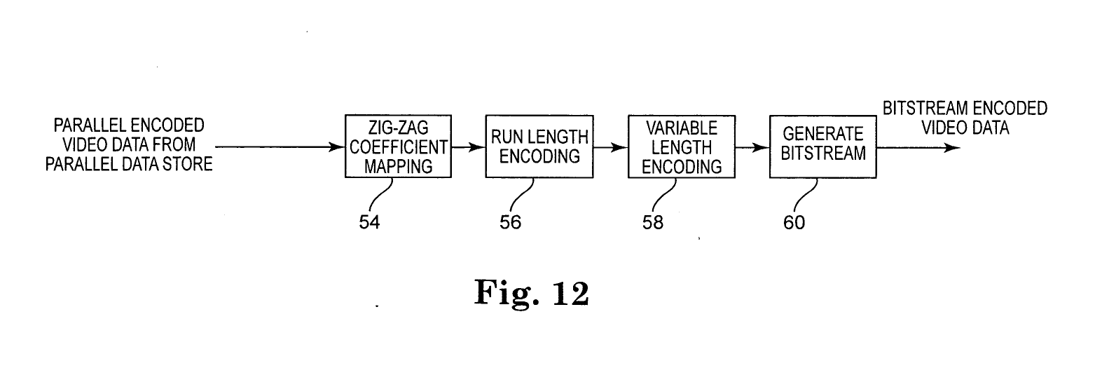

FIG. 12 is a flowchart illustrating the additional sequential processes needed to complete the encoding of video data started by parallel processor 3. Parallel encoded video data from a parallel data store is sent to a zigzag coefficient mapping module 54, a run length encoding module 56, a variable length encoding module 58 and finally to a bitstream generation module 60. The resulting encoded video bitstream is sent via system interface 7 to application(s) running on the host computer.

The above-described apparatus and method for encoding/decoding/transcoding video data significantly decreases the time required for data processing allowing system operators to offer enhanced services and/or lower costs to customers. A further advantage of the inventive approach in encoding/decoding/transcoding video data is that the parallel processor component architecture is scalable and can be designed to meet both current and future requirements. In a preferred embodiment the bitstream processor is implemented in a Field Programmable Gate Array or similar programmable hardware to further enhance operating performance.

What is claimed is:

1. An A/V data processing system for efficiently managing A/V data, comprising:
a control processor,
a memory device operatively coupled to the control processor;
an analog input device for receiving analog video streams and producing a corresponding digital data stream to be transferred to the control processor;
a digital input device for receiving digital a/v data and appropriately transferring data to the control processor;
a bitstream processor coupled to the control processor, the bitstream processor configured to parse received a/v data and provide timing data related the parsed a/v data, the bitstream processor also capable of receiving a processed video signal an appending timing data therefore; and
a parallel processor capable of multiple data processing operations in parallel including the processing of analog video streams received from the input device to produce the processed video signal, the parallel processor for further receiving parsed a/v data and produce a processed analog video signal, wherein the control processor coordinates efficiencies by communicating with the bitstream processor and the parallel processor to allow parallel processing of parsed data streams.

2. The A/V data processing system of claim 1 wherein the control processor further comprises:
a process bus controller coupled to the bitstream processor;
a bus bridge coupled to the process bus controller, the bus bridge further coupled to a system bus controller, a parallel processor bus controller and a peripheral bus controller, the system bus controller configured to accommodate communication via a system interface, the parallel processor bus controller configured to accommodate communication with the parallel processor, and the peripheral bus controller configured to accommodate communication with the analog input device and the digital input device; and
a memory controller coupled to the memory device to accommodate communication with the memory device.

3. The system of claim 2 wherein the memory device is a separate component.

4. The system of claim 1 further comprising a management processor coupled to the system controller and the bitstream processor to manage the exchange of information therebetween, including providing timing information for insertion by the bitstream processor.

5. A method for managing and processing audio/visual signals in a processing system, comprising:
receiving the audio/visual signals in a first format;
determining if encoding processes, decoding processes or transcoding processes are necessary to generate an audio/visual signal in a desired format, and
if encoding processes are necessary, receiving the audio/visual signal of the first format which is an analog format, digitizing the audio/visual signal and remapping to a block format before transferring the bock format to a parallel processor for encoding the image in a digital format and passing the digital format to a bitstream processor to insert timing information, thus creating an encoded audio/visual signal capable of storage and further processing;
if decoding processes are necessary, transferring the audio/visual signals to the bitstream processor to parse timing information and signal information, and then transferring the parsed timing and signal information to the parallel processor for decoding of images and the production of a decoded audio/visual signal which is capable of being output by an a/v output interface; and
if transcoding processes are necessary, receiving the audio/visual signal of the first format and transferring to the bitstream processor for parsing of timing information and signal information and then transferring the parsed timing and signal information to the parallel processor for partial decoding of the signal and subsequent encoding in a second format, and then transferring back to the bitstream processor to complete the encoding into the second format.
